(19) United States
(12) Patent Application Publication
(10) Pub. No.: US 2008/0151729 A1
(43) Pub. Date: Jun. 26, 2008

(54) OPTICAL RECORDING MEDIUM AND OPTICAL RECORDING AND REPRODUCING APPARATUS

(75) Inventors: Yasuhiro Satoh, Yokohama-shi (JP); Sumio Ashida, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/964,466

(22) Filed: Dec. 26, 2007

(30) Foreign Application Priority Data
Dec. 26, 2006 (JP) 2006-349528

(51) Int. Cl. G11B 7/26; G11B 7/20

(52) U.S. Cl. 369/94; 369/283

(57) ABSTRACT

An optical recording medium includes a plurality of information layers each having a recording layer for recording information, wherein at least one of the information layers includes an optical change layer which optical constant changes by light irradiated thereon and restores to an original value after completion of the light irradiation.

The entire disclosure of Japanese Patent Application No. 2006-349528 filed on Dec. 26, 2006, including specification, claims, drawings and abstract is incorporated herein by reference in its entirety.

### BACKGROUND OF THE INVENTION

1. Field of the Invention

The present invention relates to an optical recording medium and an optical recording and reproducing apparatus capable of recording and reproducing information.

2. Description of the Related Art

An optical disk represented by a CD or a DVD has spread as a medium for storing data such as sound, images or moving images and has been put into practical use as a read-only medium and a writable medium. A multi-layer optical disk having a plurality of recording layers has been proposed as one of methods of improving a recording capacity of the medium.

An optical recording/reproducing apparatus is configured in a manner that a laser light is irradiated on an optical disk, then it is determined whether the irradiated portion is a recorded portion or a non-recorded portion in accordance with a light quantity of a reflection light which is reflected on the disk and returns to a pick-up, and recording or reproducing is performed in accordance with the determination result.

In the case of performing recording or reproducing with respect to a target recording layer in a multi-layer optical disk, it is required to focus on the target layer by a light transmitted through one or more recording layers closer to the light incident side than the target layer thereby to perform recording or reproducing. Thus, the recording layers are required to be semitransparent with respect to the recording/reproducing light, as disclosed in JP-A-2002-342980. Further, as the number of the layers increases, it is required to increase the transmissivity of the recording layers and simultaneously reduce the reflection factor thereof in advance. As a result, at the time of the reproduction, a light quantity of the reflection light becomes small and so an S/N ratio degrades. Further, there arises a problem that alight is unlikely focused or a light is defocused upon reproduction even if a light is focused once.

### SUMMARY OF THE INVENTION

The invention may provide an optical recording medium including a plurality of information layers each having a recording layer for recording information, wherein at least one of the information layers includes an optical change layer which optical constant changes by light irradiated thereon and restores to an original value after completion of the light irradiation.

Further, the invention may provide an optical recording and reproducing apparatus including: an optical recording medium including a plurality of information layers each having a recording layer for recording information, at least one of the information layers having an optical change layer which optical constant changes by light irradiated thereon and restores to an original value after completion of the light irradiation; a first light irradiation unit which irradiates first light on the optical change layer to change the optical constant; and a second light irradiation unit which irradiates second light on the recording layer in a state where the optical constant is changed.

### BRIEF DESCRIPTION OF THE DRAWINGS

Embodiment may be described in detail with reference to the accompanying drawings, in which:

FIG. 1 is a graph showing the temperature dependency of optical constants of a ZnO thin film at the wavelength of 405 nm;

FIG. 2 is a graph showing the temperature dependency of optical constants of an AlGe thin film at the wavelength of 405 nm;

FIG. 3 is a conceptual diagram for explaining the recording/reproducing method according to an embodiment of the invention;

FIG. 4 is a sectional diagram of a disk A for explaining the first embodiment of the invention;

FIG. 5 is a conceptual diagram for explaining the optical system for the recording/reproducing method according to the first embodiment of the invention;

FIG. 6 is a sectional diagram of a disk C for explaining the second embodiment of the invention;

FIG. 7 is a sectional diagram of a disk E for explaining the third embodiment of the invention; and

FIG. 8 is a conceptual diagram for explaining the optical system for the recording/reproducing method according to the third embodiment of the invention.

### DETAILED DESCRIPTION OF THE INVENTION

The embodiments of the invention will be explained with reference to drawings. In the following explanation of the drawings, identical or similar portions are referred to by the common or similar symbols. The drawings are typical ones and so it should be noted that the relation between a thickness and plane sizes and the ratios among the thicknesses of respective layers differ from the actual ones. Thus, the concrete thicknesses and sizes are should be determined with reference to the following explanation. Further, of course, the relation and ratios of the sizes may partially differ among the drawings.

First, an optical recording medium according to an embodiment of the invention will be explained. The optical recording medium is configured by laminating a plurality of information layers. Each of the information layers includes a recording layer, a protection layer and a reflection layer. Some of the information layers each includes, in addition to the recording layer, an optical constant change layer having an optical constant which changes in response to light irradiation and restores to an original value when the light irradiation stops. Due to the presence of the optical constant change layer, at the time of recording/reproducing, when an optical change induction light for inducing the change of the light constant of the optical constant change layer is irradiated together with a recording/reproducing light on a target information layer, the reflection factor of a layer to be recorded/reproduced is increased and simultaneously the contrast of the reflection factor can be enhanced. Further, as described above, since the multi-layer optical disk is required to increase the transmissivity of the single layer and also secure the reflection factor thereof, a margin in the optical design is quite small. On the other hand, due to the presence of the optical constant change layer according to the embodiment, it is possible to design a film in a manner that the reflection factor and the contrast of the reflection factor are large only at the time of the recording/reproducing, whilst the reflection factor is low and the transmissivity is high during a time other than the recording/reproducing.

The optical constant change layer is not necessarily contained in all of the information layers but may be contained in one or more of the information layers.

Supposing that the total number of the information layers is n and the respective information layers are counted from the incident side of a recording/reproducing light, the n-th information layer which is the innermost side information layer is not required to secure the transmissivity, the n-th layer can be designed to have a high reflection factor in advance and is not required to have the optical change layer. Further, in view of the manufacturing cost of fabricating films, it is preferable that only one of the information layers is provided with the optical change layer according to the embodiment,

The film thickness of the information layer configured by the optical change layer, recording layer, and suitably selected protection layer and reflection layer is preferably 500 nm or less. When the film thickness exceeds 500 nm, a light beam expands within the information layer and so a beam spot becomes large at the time of the recording/reproducing, which results in the reduction of the recording capacity due to the enlargement of a recording mark and the increase of the consumption power of a light source due to a large recording light power required upon recording. The material of the optical change layer and the position where the optical change layer is disposed within the information layer may be suitably changed in accordance with the optical property of the films to be combined and the signal polarity of the information layer, and so the optical change layer may be on the inner side or the light incident side than the recording layer.

The optical change layer is formed by the material which optical constant changes at the wavelength of the recording/reproducing light in response to the irradiation of the optical change induction light. The material may be thermochromism material or supersaturated absorption material.

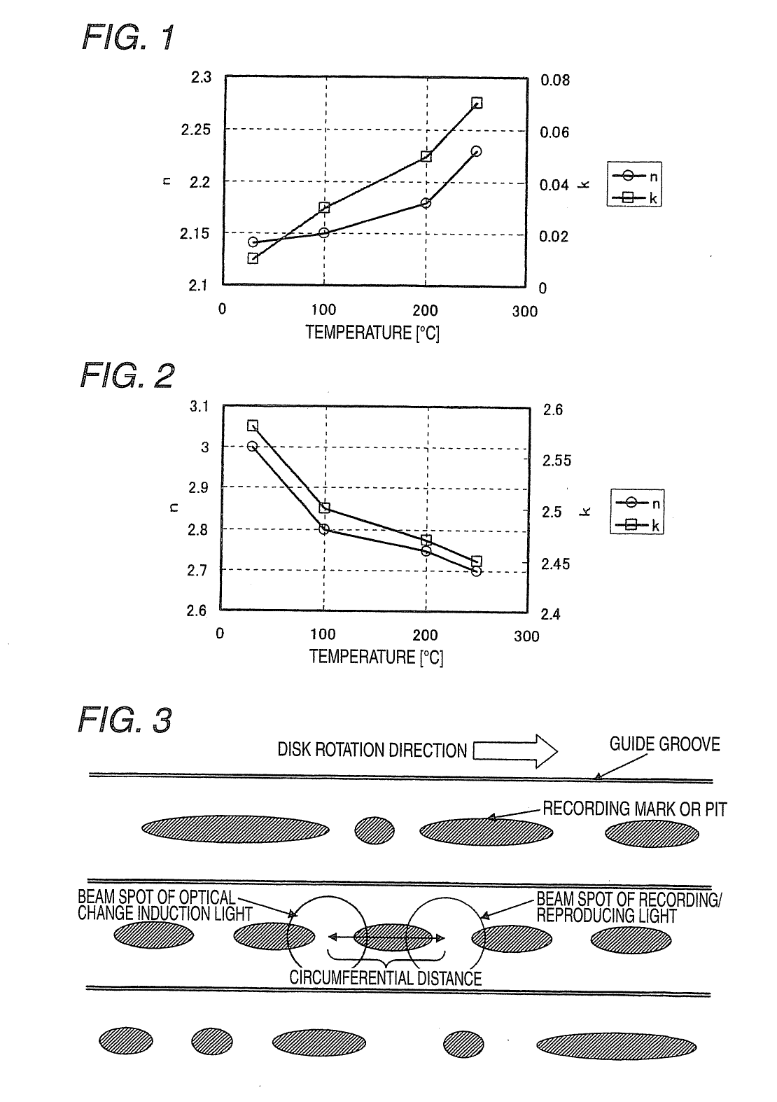

The thermochromism material is material which construction changes optically when absorbing heat and so the optical constant thereof changes. The thermochromism material may be inorganic thermochromism material such as metallic oxide or organic thermochromism material such as lactone or fluorine added with alkali or leuco dye added with organic acid. Among these materials, it is preferable to use the material which optical constant changes at the wavelength near the absorption end when the forbidden band thereof changes due to the temperature change. This is because such the material unlikely changes its composition and shape and so is excellent in its durability even if the chemical construction thereof changes repeatedly due the temperature change. Concretely, such the material may be ZnO, SnO₂, CeO₂, NiO₂, In₂O₃, TiO₂, Ta₂O₅, VO₂, SrTiO₃, AlGe, for example. For example, in the case where the wavelength of a reproduction light is in a range of 380 nm to 415 nm (for example, 405 nm), it is particularly preferable to use ZnO which absorption end wavelength in the normal temperature is near 375 nm as the optical change layer. FIG. 1 shows the temperature dependency of the refractive index n and the attenuation coefficient k of the single film of ZnO at the wavelength of 405 nm. ZnO is film material in which both the refractive index and the attenuation coefficient increase at the wavelength of 405 nm used in the optical disk of the next generation when the temperature increases from the normal temperature. Each of the refractive index and the attenuation coefficient restores to an original value when the temperature reduces to the normal temperature. On the other hand, as shown in FIG. 2 as a graph of the temperature dependency characteristics between the refractive index n and the attenuation coefficient k at the wavelength of 405 nm, AlGe is material in which both the refractive index and the attenuation coefficient reduce when the temperature reduces. In this case, also each of the refractive index and the attenuation coefficient restores to an original value when the temperature reduces to the normal temperature.

Although supersaturated absorption material absorbs light when the intensity of an incident light is low, the absorption coefficient thereof becomes small and simultaneously the refractive index thereof changes when the light intensity is increased. Such the supersaturated absorption material may be a semiconductor fine particle dispersion film or organic dye such as cyanine dye or phthalocyanine dye. The material of the semiconductor fine particle dispersion film may be Cu, halide of Ag, Cu oxide, AgSe, AgTe, SrTe, SrSe, CaSi, ZnS, ZnTe, CdS, CdSe, CdTe etc. Further, as the base material necessary for dispersing the semiconductor fine particles, there is transparent dielectric material such as SiO₂, Si₃N₄, Ta₂O₅, TiO₂, ZnS—SiO₂. In order to adjust the wavelength for attaining the supersaturated absorption effects of the semiconductor fine particle dispersion film, the semiconductor material used so as to cope with the wavelength is selected and each of the diameter of the fine particle and the volume content of the fine particles is adjusted, whereby each of the life time of the deexcitation and the excitation probability can be controlled.

The recording layer used in the information layer is formed by the material having properties that the optical constant thereof changes in response to the irradiation of a laser light, recording marks are formed, and the reflection factor with respect to the reproduction light differs largely between the recording mark portion and the portion other than the recording mark portion. Although the material of the recording layer is not limited to particular material, the following material may be used. That is, a phase change recording filmutilizing the change of the optical constant due to the phase change of the recording mark area from the crystalline state to the non-crystalline state. An organic dye film such as azo-metal complex dye or cyanine dye or an inorganic recording film such as AlSi, Zn—S—Mg—O—Si which changes non-reversibly by the light. An eutectic crystallization type recording film in which the recording mark is formed by eutectic alloy configured by element constituting two layers thereby to change the reflection factor. A configuration change type recording film which utilizes the reflection factor change due to the configuration change of the recording mark area (changes due to perforation, pit forming, babble forming and surface shape change) which is formed at the recording layer. The recording layer may be a layer having a pattern of unevenness which is formed in advance on a substrate or a resin by the injection molding etc.

Next, the method of recording and reproducing the optical recording medium as described above will be explained. The apparatus includes an irradiating unit for irradiating the recording/reproducing light on a recording/reproducing layer (one of the recording layers to be recorded or reproduced of the optical recording medium and an irradiating unit for irradiating the optical change induction light for inducing the change of the optical constant of the optical constant change layer. Although the two lights, that is, the recording/reproducing light and the optical change induction light are employed, these lights may be generated by using two light sources respectively or may be generated by using a single light source in a manner that a light is divided into two lights by a beam splitter and the two lights are used as the recording/reproducing light and the optical change induction light respectively. As the light source for the recording/reproducing, a semiconductor layer (LD) usually used for the optical recording may be employed. On the other hand, as the light source for the optical change induction, a semiconductor laser may also be employed but the wavelength thereof is not necessarily same as the wavelength for the reproduction. In the following explanation, the recording/reproducing apparatus (method) means an apparatus for recording or reproducing and so may be a record-only apparatus, a read (playback)-only apparatus or a recording/reproducing apparatus (method) capable of performing both the recording and the reproduction.

The area of the optical change induction area is preferably larger than the area of the recording/reproducing optical spot. To be concrete, supposing that the diameter of the beam spot of the optical change induction light is ra and the diameter of the beam spot of the recording/reproducing light is rb, ra is preferably equal to or lager than rb. If ra is smaller than rb, within the beam spot area of the recording/reproducing light, there exists an area which can not be subjected to the optical change effects due to the optical change induction light, and so the remarkable effects of the invention can not attain. Further, since there arises the distribution of the reflection factor within the beam spot of the recording/reproducing light, the quality of are produced signal degrades remarkably, which results in the increase of error rate. As explained above, as the light source for the optical change induction light, a light source having a large irradiation area such as a light emitting diode, a xenon lamp or a mercury lamp may be employed. In the case where the thermochromism material is used as the optical change layer, a heat source such as an infrared ray lamp may be used for the optical change induction. In this case, since the manufacturing cost of the optical recording/reproducing apparatus increases if the light source can not be miniaturized, the wavelength of each of the recording/reproducing light and the optical change induction light is preferably equal to or larger than 350 nm and equal to or smaller than 850 nm.

In the recording/reproducing method according to the embodiment of the invention, as shown in FIG. 3, supposing that a rotary linear speed at the time of the recording/reproducing is v and a time period required from a time point where the optical change induction light is irradiated to a time point where the change of the optical constant is completed and then the optical constant restores to the original value is t, it is particularly preferable to set a circumferential distance d so as to satisfy a relation of d≦v·t, where the circumferential distance is a distance between the center of a beam spot of the recording/reproducing light on a optical recording medium and the center of a beam spot of the optical change induction light on the optical recording medium. If d>v·t, since the recording/reproducing is performed after the change of the optical constant already disappears, the effects of the invention can not be attained.

### FIRST EMBODIMENT

### Single-Sided Three-Layer Type Rewritable Optical Recording Medium

Next, the first embodiment of the invention will be explained. In this case, the explanation will be made as to the embodiment where the invention is applied to a rewritable phase-change optical recording medium. The phase-change optical recording medium may have two or more information layers.

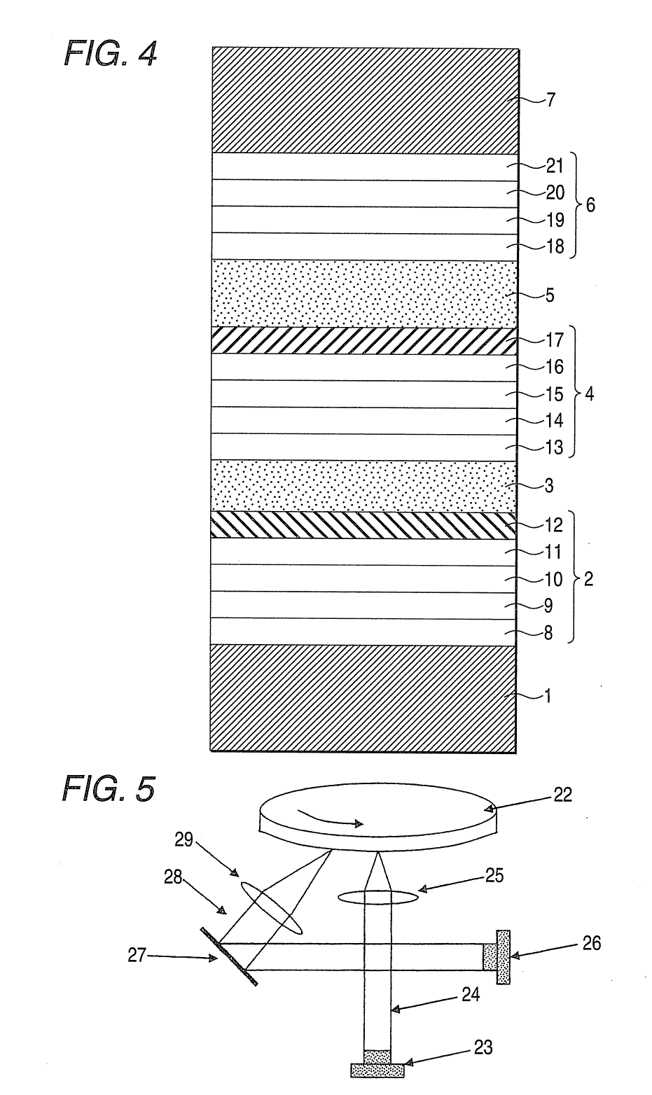

The optical recording medium according to the first embodiment of the invention is configured as a rewritable optical recording medium of a single-sided three-layer type as shown in FIG. 4, in which layers are laminated in the order of a first substrate 1, a first information layer 2, a spacer layer 3, a second information layer 4, a spacer layer 5, a third information layer 6 and a second substrate 7, from the light incident side. Further, the first (second) information layer is configured by laminating a first dielectric film 8 (13) serving as a protection layer, a phase change recording film 9 (14) serving as a recording layer, a second dielectric film 10 (15) serving as a protection layer, a reflection film 11 (16) serving as a reflection layer and an optical change layer 12 (17), from the light incident side. The third information layer is configured by laminating a first dielectric film 18 serving as a protection layer, a phase change recording film 19 serving as a recording layer, a second dielectric film 20 serving as a protection layer and a reflection layer 21, from the light incident side. Hereinafter, the first, second and third information layers will be referred to as L0, L1 and L2 layers, respectively.

The first substrate is configured by material which is transparent with respect to the wavelength of the recording/reproducing light and does not prevent the light from being incident into the information layer. The material is not limited to particular material but may be thermoplastic transparent resin (plastics) such as polycarbonate, amorphous polyolefin, thermoplastic polyimide, PET (polyethylen terephthalate), PEN (polyether nytril), PES (polyether sulphone) or thermoset resin such as thermoset polyimide, ultraviolet curing type acrylic resin or the combination thereof. The thickness of the first substrate is not limited particularly but is suitably almost in a range of 0.1 to 1.2 mm.

The material of the protection layer is not limited to particular material but configured by material which is transparent with respect to the wavelength of the recording/reproducing light. To be concrete, the material preferably contains, as a main component, at least one dielectric material selected from a group of Al₂O₃, AlN, ZnS, GeN, GeCrN, CeO, SiO, SiOC, SiN, SiC, SiO₂, Cr₂O₃ and Ta₂O₅.

The phase change recording film used as the recording layer may be configured by material such as GeSbTeBi, GeSbTe, GeBiTe, GeSbTeSn, AgInSbTe, InSbTe, AgInGeSbTe or GeInSbTe or material added with Sn, In, B or Mn etc. thereto. A boundary layer formed by GeN, ZrO₂, CrO or SiN etc. may be provided on one or both major surfaces of the phase change recording film.

The reflection layer may be configured by material containing Ag, Al, Au or Cu as a main component.

ZnO is used as the material of the optical change layer since 405 nm is selected as the wavelength of the recording/reproducing light.

The second substrate is configured by material capable of applying a suitable intensity to the optical recording medium. Since the optical characteristics of the material constituting the second substrate is not limited in particular, the material may be transparent or opaque. The material constituting the substrate may be glass, polycarbonate, amorphous polyolefin, thermoplastic polyimide, thermoplastic resin thermoset polyimide such as PET, PEN, PES, or thermoset resin such as ultraviolet curing type acrylic resin or the combination thereof. The thickness of the second substrate is not limited particularly but is suitably almost in a range of 0.3 to 1.2 mm.

Further, on the inner side major surface of the second substrate, not-shown guide grooves and pits each having a concavo-convex shape corresponding to recording information are formed. Each of the pits and the guide grooves suitably has a pitch almost in a range of 0.3 to 1.6 μm and a depth almost in a range of 30 to 200 nm.

At the time of the recording/reproducing, in the case of reproducing the L0 layer closest to the light incident side, the reproducing light is focused on the L0 layer and the L0 layer is accessed via the first substrate. In the case of reproducing the L1 layer, the reproducing light is focused on the L1 layer and the L1 layer is accessed via the L0 layer and the first spacer layer in addition to the first substrate. In the case of reproducing the L2 layer, the reproducing light is focused on the L2 layer and the L2 layer is accessed via the first substrate, the L0 layer, the first spacer layer, the L1 layer and the second spacer layer.

According to the embodiment, the wavelength of the recording/reproducing light and the wavelength of the optical change induction light are set to 405 nm and 650 nm, respectively. Two LDs having the wavelengths of 405 nm and 650 nm are used as a light source for the recording/reproducing light and a light source for the optical change induction light, respectively, as shown in FIG. 5. The LD 26 for the optical change induction light irradiates the optical change induction light 28 on a total reflection mirror 27, and then the reflected optical change induction light 28 is irradiated on an optical recording medium 22 via an objective lens 29 for the optical change induction light. Thereafter, the LD 23 for the recording/reproducing light irradiates the recording/reproducing light 24 on the optical recording medium 22 via an objective lens 25 for the recording/reproducing light. In the case of irradiating the optical change induction light 28 and the recording/reproducing light 24 on the optical recording medium 22, the LEDs 23, 25, the total reflection mirror 27 and the objective lenses 22, 25 are disposed and further the recording/reproducing light 24 and the reflected optical change induction light 28 are irradiated on the optical recording medium 22 so as to shift their optical axes to each other so that the focal points of these lights locate at the positions of the same radius.

Although an example of the first embodiment according to the invention is explained hereinafter, the invention is not limited to the following example so long as not departing from the gist of the invention.

### FIRST EXAMPLE

### Single-Sided Three-Layer Type Rewritable Optical Recording Medium

On a polycarbonate substrate (hereinafter called the first substrate) with a thickness of 0.6 mm on which grooves each having a track pitch of 0.34 μm and a depth of 50 nm were formed, a ZnS—SiO₂ film (thickness of 20 nm), a GeInSbTe film (thickness of 5 nm), a ZnS—SiO₂ film (thickness of 20 nm), a silver alloy film (thickness of 5 mm) and a ZnO film (thickness of 30 nm) were formed sequentially, thereby forming the first information layer L0. The ZnS—SiO₂ film serves as the protection layer, the GeInSbTe film serves as the recording layer, the silver alloy film serves as the reflection layer and the ZnO film serves as the first optical change layer. All the films were formed by the sputtering. Each of the layers L1 and L2 employed the ZnS—SiO₂ film and the GeInSbTe film as the protection layer and the recording layer, respectively.

Succeedingly, an UV cured resin was coated with a thickness of 20 μm as the first spacer layer on the first optical change layer on the fist substrate. Next, an acrylic substrate with a thickness of 1.1 mm on which grooves each having a track pitch of 0.34 μm and a depth of 50 nm were formed was prepared in another process. Then, the acrylic substrate was disposed on the surface of the UV cured resin, and an ultraviolet (UV) light was irradiated thereon while applying a pressure uniformly from both sides thereof to harden the UV cured resin, and the acrylic substrate was exfoliated from the UV cured resin. As the second information layer L1, a ZnS—SiO₂ film (thickness of 20 nm), a GeInSbTe film (thickness of 5 nm), a ZnS—SiO₂ film (thickness of 20 nm), a silver alloy film (thickness of 5 nm) and a ZnO film (thickness of 30 nm) were formed sequentially on the major surface of the UV cured resin.

On a polycarbonate substrate (hereinafter called the second substrate) with a thickness of 0.6 mm on which grooves each having a track pitch of 0.34 μm and a depth of 50 nm were formed, a silver alloy film (thickness of 5 nm), a ZnS—SiO₂ film (thickness of 20 nm), a GeInSbTe film (thickness of 15 nm) and a ZnS—SiO₂ film (thickness of 20 nm) were formed sequentially, thereby forming the third information layer L2. Finally, an UV cured resin was coated with a thickness of 20 μm as the second spacer layer on the second optical change layer on the first substrate, and the coated surface of the UV cured resin was laminated with the film forming surface of the ZnS—SiO₂ film on the second substrate thereby to prepare the single-sided three-layer type rewritable optical recording medium as shown in FIG. 4. The disk thus formed is called a disk-A.

### COMPARATIVE EXAMPLE 1

### Single-Sided Three-Layer Type Rewritable Optical Recording Medium

A single-sided three-layer type rewritable optical recording medium was prepared by the same material and the same processes as the first example except that a ZnS—SiO₂ film was formed so as to have the same thickness as that of the ZnO film in place of providing the ZnO film as the optical change layer in the embodiment. The disk thus formed is called a disk-B.

Each of the disks-A and B thus prepared was set to an initializing apparatus, then an elliptical beam with a width of 50 μm and a length of 1 μm was irradiated thereon thereby to initialize (crystallize) the recording film on the entire surface thereof.

The recording and erasing test of such the optical disk was performed in the following manner. An optical system as shown in FIG. 5 was employed for the recording and erasing test. The objective lens having an numerical aperture (NA) of 0.65 and the LD having the wavelength of 405 nm were used as the recording/reproducing pickup, and the objective lens having an NA of 0.45 and the LD having the wavelength of 650 nm were used for the optical change induction light. The circumferential distance between the center of the beam spot of the recording/reproducing light and the center of the beam spot of the optical change induction light on the optical recording medium was set to 1 μm (angle of circumference of 2.5·0.10⁻⁴ (rad)). The recording test was held by using the recording linear velocity of 5.6 m/sec and a 3T (T is an index representing the signal length) signal (in which each of the mark length and the space length is 0.26 μm).

The test was made in the following manner. In the case of estimating the characteristics of the land or the groove track, the test was made not to influence on signals recorded on other tracks. The CNR (carrier to noise ratio) characteristics was measured in the following manner. First, the recording power and erasing power dependency of the CNR was measured thereby to obtain an optimum power. Then, a random pattern was overwritten for ten times on the land or the groove track and further the 3T signal was written with the optimum power. At this time point, the CNR of the 3T signal on the track was measured.

Each of the L0, L1 and L2 layers was estimated. Supposing that the reflection factor and the transmissivity at the wavelength of the recording/reproducing light before the recording/reproducing are Rc and Tc, respectively, as to the disk-A, Rc=2.6% and Tc=79% for L0, Rc=2.4% and Tc=81% for L1 and Rc=3.1% and Tc=0% for L2, whilst as to the disk-B, Rc=3.0% and Tc=76% for L0, Rc=2.6% and Tc=75% for L1 and Rc=3.1% and Tc=0% for L2. As to each of the L0 and L1 layers, the reflection factor of the disk-B was higher than that of the disk-A and hence the transmissivity of the disk-B was lower than that of the disk-A. At the time of the recording test, the LD for the optical change induction having the wavelength of 650 nm was also lightened together with the LD for the recording/reproducing having the wavelength of 405 nm and the lights were focused on the layer to be recorded and reproduced. The irradiation of the light having the wavelength of 650 nm was stopped at the time of recording and reproducing the layer L2. After the recording, the reflection factor and the transmissivity of each of the mark portion and the space portion were measured in a state of irradiating the light having the wavelength of 650 nm. Supposing that the reflection factor of the mark portion is Ra and the reflection factor and the transmissivity at the space portion are Rc* and Tc*, respectively, as to the disk-A, Rc*=3.6%, Ra=1.1% and Tc*=72% for L0, Rc*=3.1%, Ra=1.2% and Tc*=73% for L1, and Rc*=3.1%, Ra=4.1% and Tc*=0% for L2. On the other hand, as to the disk-B, Rc* was substantially same as Rc and Tc was also substantially same as Tc* for each of the first to third information layers, whilst Ra=0.9% for L0, Ra=1.0% for L1 and Ra=4.1% for L2. As to the disk-A, due to the irradiation of the optical change induction light, the reflection factor of each of the layers L0 and L1 increased and also the contrast of the reflection factor thereof increased. When the CNRs of the L0 and L1 layers were measured, it was proved that as to the disk-A, the CNRs were good values of 49.1 dB for the L0 layer and 49.7 dB for the layer L1 due to the two contributions that the contrast of the reflection factor was large and that the interlayer crosstalk from the non-recording/reproducing layer was reduced due to the reduction of the transmissivity which was caused by the irradiation of the optical change induction light on the optical change layer at the time of reproducing the respective layers. As to the disk-B, the CNRs were low values of 43.5 dB for the L0 layer and 42.9 dB for the layer L1. Further, as to the disk-A, the reflection factor became high due to the irradiation of the optical change induction light. In contrast, as to the disk-B, since the reflection factor was low, there sometimes arose a trouble that the light was defocused after a while even if the light was focused a the time of the disk estimation. Besides, the above results are arranged in Table 1, as follows.

TABLE 1

| Disk | | Rc | Tc | Ra | Rc* | Tc* | CNR |
|---|---|---|---|---|---|---|---|
| A | L0 | 2.6 | 79 | 1.1 | 3.6 | 72 | 49.1 |
| | L1 | 2.4 | 81 | 1.2 | 3.1 | 73 | 49.7 |
| | L2 | 3.1 | 0 | 4.1 | 3.1 | 0 | |
| B | L0 | 3.0 | 76 | 0.9 | 3.0 | 76 | 43.5 |
| | L1 | 2.6 | 75 | 1.0 | 2.6 | 75 | 42.9 |
| | L2 | 3.1 | 0 | 4.1 | 3.1 | 0 | |

The unit of each of the reflection factor and the transmissivity is % and the unit of CNR is dB.

### SECOND EMBODIMENT

### Single-Sided Three-Layer Type Write-Once Optical Recording Medium

Next, an optical recording medium according to the second embodiment of the invention will be explained. In this case, the explanation will be made as to the embodiment where the invention is applied to a write-once optical recording medium. The write-once recording medium may have two or more information layers.

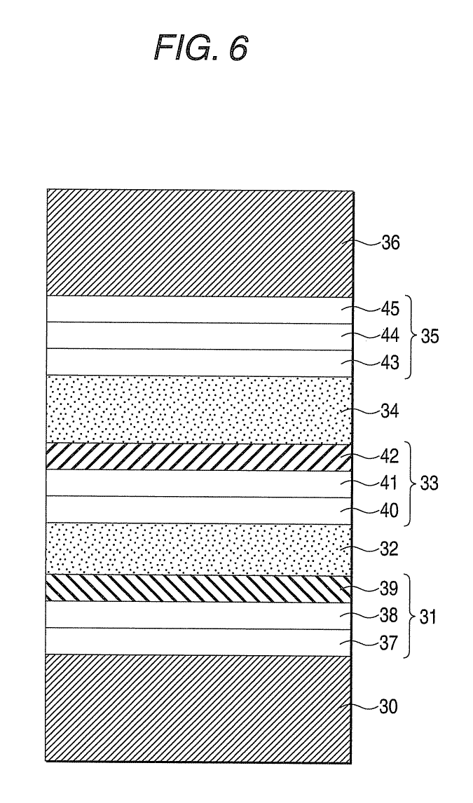

The optical recording medium according to the second embodiment of the invention is configured as a write-once optical recording medium of a single-sided three-layer type as shown in FIG. 6, in which layers are laminated in the order of a first substrate 30, a first information layer 31, a first spacer layer 32, a second information layer 33, a second spacer layer 34, a third information layer 35 and a second substrate 36, from the light incident side. Hereinafter, the first, second and third information layers will be referred to as L0, L1 and L2 layers, respectively. The basic configuration of the L0 layer is that a first protection film (not shown), an organic dye recording film 37 in which the recording is performed non-reversibly by irradiating light, a second protection film (not shown), a metal reflection film 38 and a first optical change layer 39 are laminated sequentially from the light incident side. The basic configuration of the L1 layer is that a first protection film (not shown), an organic dye recording film 40 in which the recording is performed non-reversibly by irradiating light, a second protection film (not shown), a metal reflection film 41 and a second optical change layer 42 are laminated sequentially from the light incident side. The basic configuration of the L2 layer is that a first protection film 43, an organic dye recording film 44 in which the recording is performed non-reversibly by irradiating light, a second protection film (not shown) and a metal reflection film 44 are laminated sequentially from the light incident side. The characteristics and material etc. of each of the substrates, the protection films, the metal reflection films and the spacer layers are same as those of the first embodiment, and so the explanation thereof is omitted.

An azo-metal complex dye film is used as the recording film. All the first and second dielectric protection films are not necessarily disposed and so one of them may be disposed. The positions where the dielectric films are disposed may be changed suitably in accordance with the condition such as the characteristics of the films to be combined and the linear velocity to be used. The optical change layer according to the embodiment is used as each of the first and second information layers.

According to the embodiment, the wavelength of the recording/reproducing light and the wavelength of the optical change induction light are set to 405 nm and 650 nm, respectively. Two LDs having the wavelengths of 405 nm and 650 nm are used as a light source for the recording/reproducing light and a light source for the optical change induction light, respectively, as shown in FIG. 5.

Although an example of the second embodiment according to the invention is explained hereinafter, the invention is not limited to the following example so long as not departing from the gist of the invention.

### SECOND EXAMPLE

### Single-Sided Three-Layer Type Write-Once Optical Recording Medium

On a polycarbonate substrate (hereinafter called the first substrate) with a thickness of 0.6 mm on which grooves each having a track pitch of 0.4 μm and a depth of 50 nm were formed, a ZnS—SiO₂ film (thickness of 20 nm), a GeInSbTe film (thickness of 5 nm), an organic dye film (thickness of 12 nm), a silver alloy film (thickness of 10 nm) and a ZnO film (thickness of 30 nm) were formed sequentially, thereby forming L0 layer. The ZnO film was the first optical change layer of the embodiment. The organic dye film is coated by the spin coat, and each of the silver alloy film and the ZnO film was formed by the sputtering within Ar gas.

Succeedingly, an UV cured resin was coated with a thickness of 20 μm as the first spacer layer on the first optical change layer on the first substrate. Next, an acrylic substrate with a thickness of 1.1 mm on which grooves each having a track pitch of 0.4 μm and a depth of 50 nm were formed was prepared in another process. Then, the acrylic substrate was disposed on the surface of the UV cured resin, and an ultraviolet (UV) light was irradiated thereon while applying a pressure uniformly from both sides thereof to harden the UV cured resin, and the acrylic substrate was exfoliated from the UV cured resin. As the L1 layer, an organic dye film (thickness of 10 nm), a silver alloy film (thickness of 10 nm) and a ZnO film (thickness of 25 nm) were formed sequentially on the major surface of the UV cured resin.

On a polycarbonate substrate (hereinafter called the second substrate) with a thickness of 0.6 mm on which grooves each having a track pitch of 0.4 μm and a depth of 50 nm were formed, a silver alloy film (thickness of 5 nm), an organic dye film (thickness of 20 nm) and a dielectric protection film (thickness of 20 nm) were formed sequentially, thereby forming the L2 layer. The dielectric protection film is formed by SiO₂ using the sputtering. Finally, an UV cured resin was coated with a thickness of 20 μm as the second spacer layer on the second optical change layer on the first substrate, and the coated surface of the UV cured resin was laminated with the film forming surface of the dielectric protection film on the second substrate thereby to prepare the single-sided three-layer type write-once recording medium as shown in the figure. The disk thus formed is called a disk-C.

### COMPARATIVE EXAMPLE 2

### Single-Sided Three-Layer Type Write-Once Optical Recording Medium

A single-sided three-layer type write-once recording medium was prepared by the same material and the same processes as the second example except that the ZnO film serving as the optical change layer in the embodiment is eliminated. The disk thus formed is called a disk-D.

The recording test of such the write-once optical disk was performed in the following manner. For the recording test, as shown in FIG. 5, an optical disk evaluation system was employed in which the objective lens having the NA of 0.65 and the LD having the wavelength of 405 nm were used as the recording/reproducing pickup, and the objective lens having the NA of 0.45 and the LD having the wavelength of 650 nm were used as the optical system for the optical change induction. The CNR (carrier to noise ratio) of the 3T (T is an index representing the signal length) signal (in which each of the mark length and the space length is 0.306 μm) was measured with the recording linear velocity of 6.61 m/sec and.

Each of the L0, L1 and L2 layers was estimated. Supposing that the reflection factor and the transmissivity at the wavelength of the recording/reproducing light before the recording/reproducing are Rc and Tc, respectively, as to the disk-C, Rc=2.2% and Tc=68% for L0, Rc=2.1% and Tc=64% for L1 and Rc=2.6% and Tc=0% for L2, whilst as to the disk-D, Rc=2.7% and Tc=65% for L0, Rc=2.6% and Tc=60% for L1 and Rc=2.9% and Tc=0% for L2. As to each of the L0 and L1 layers, the reflection factor of the disk-D was higher than that of the disk-C and hence the transmissivity of the disk-D was lower than that of the disk-C. At the time of the recording test, the LD for the optical change induction having the wavelength of 650 nm was also lightened together with the LD for the recording/reproducing having the wavelength of 405 nm and the lights were focused on the layer to be recorded and reproduced. The irradiation of the light having the wavelength of 650 nm was stopped at the time of recording and reproducing the layer L2. After the recording, the reflection factor and the transmissivity of each of the mark portion and the space portion were measured in a state of irradiating the light having the wavelength of 650 nm. Supposing that the reflection factor of the mark portion is Ra and the reflection factor and the transmissivity of the space portion are Rc* and Tc*, respectively, as to the disk-C, Rc*=3.6%, Ra=1.1% and Tc*=63% for L0, Rc*=3.1%, Ra=1.2% and Tc*=60% for L1, and Rc*=2.6%, Ra=1.1% and Tc*=0% for L2. On the other hand, as to the disk-D, Rc* was substantially same as Rc and Tc was also substantially same as Tc* for each of the first to third information layers, whilst Ra=0.9% for L0, Ra=1.0% for L1 and Ra=1.1% for L2. As to the disk-C, due to the irradiation of the optical change induction light, the reflection factor of each of the layers L0 and L1 increased and also the contrast of the reflection factor thereof increased. When the CNRs of the L0 and L1 layers were measured, it was proved that as to the disk-C, the CNRs were good values of 48.7 dB for the L0 layer and 49.5 dB for the layer L1 due to the two contributions that the contrast of the reflection factor was large and that the interlayer cross talk from the non-recording/reproducing layer was reduced due to the reduction of the transmissivity which was caused by the irradiation of the optical change induction light on the optical change layer at the time of reproducing the respective layers. As to the disk-D, the CNRs were low values of 45.5 dB for the L0 layer and 43.9 dB for the layer L0. Further, as to the disk-C, the reflection factor became high due to the irradiation of the optical change induction light. In contrast, as to the disk-D, since the reflection factor was low, there sometimes arose a trouble that the light was defocused after a while even if the light was focused a the time of the disk estimation. Besides, the above results are arranged in Table 2, as follows.

TABLE 2

| Disk | | Rc | Tc | Ra | Rc* | Tc* | CNR |
|---|---|---|---|---|---|---|---|
| C | L0 | 2.2 | 68 | 1.1 | 3.6 | 63 | 48.7 |
| | L1 | 2.1 | 64 | 1.2 | 3.1 | 60 | 49.5 |
| | L2 | 2.6 | 0 | 1.1 | 2.6 | 0 | |
| D | L0 | 2.7 | 65 | 0.9 | 2.7 | 65 | 45.5 |
| | L1 | 2.6 | 60 | 1.0 | 2.6 | 60 | 43.9 |
| | L2 | 2.9 | 0 | 1.1 | 2.9 | 0 | |

The unit of each of the reflection factor and the transmissivity is % and the unit of CNR is dB.

### THIRD EMBODIMENT

### Single-Sided Three-Layer Type Read-Only Optical Recording Medium

Next, an optical recording medium according to the third embodiment of the invention will be explained. In this case, the explanation will be made as to the embodiment where the invention is applied to a read-only optical recording medium. The read-only recording medium may have two or more information layers.

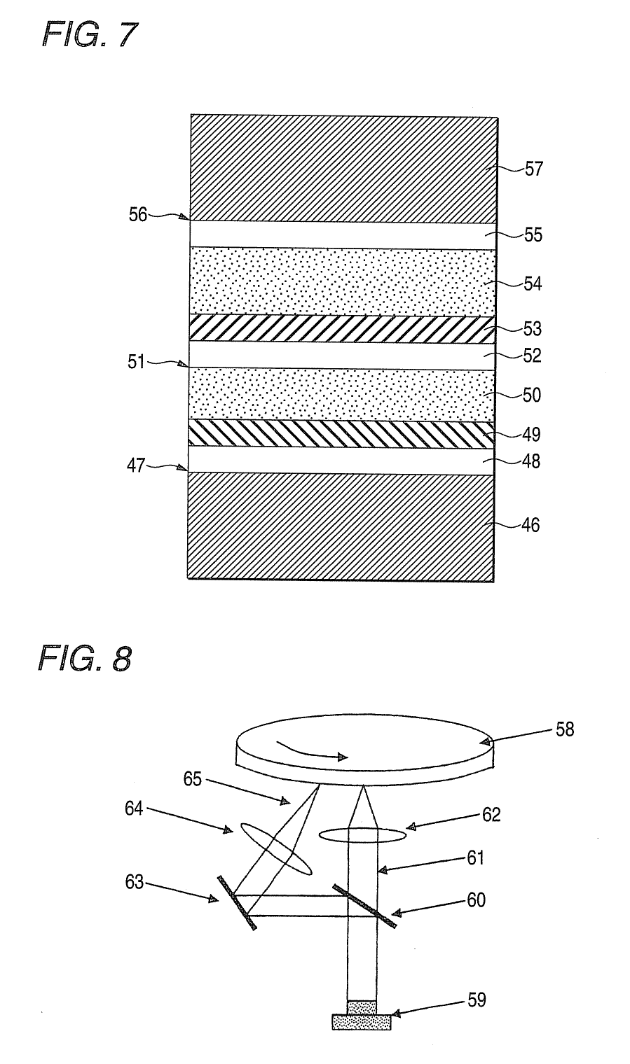

The optical recording medium according to the third embodiment of the invention is configured as a read-only optical recording medium of a single-sided three-layer type as shown in FIG. 7, in which layers are laminated in the order of a first substrate 30, a first substrate 46, a first reflection film 48, a first optical change layer 49, a first spacer layer 50, a second reflection film 52, a second optical change layer 53, a second spacer layer 54, a third reflection film 55 and a second substrate 57, from the light incident side. Further, pits are formed on the first substrate, the first spacer layer and the second substrate by the injection molding etc. thereby to form a first recording layer 47, a second recording layer 51 and a third recording layer 56, respectively, each not being shown. Hereinafter, the first, second and third information layers are called as L1, L2 and L3 layers, respectively. The characteristics and material etc. of each of the substrates, the protection films, the metal reflection films and the spacer layers are same as those of the first embodiment, and so the explanation thereof is omitted.

In this embodiment, the wavelength of each of the recording/reproducing light and the optical change induction light is set to 405 nm. Only one LD having the wavelength of 405 nm is used as a light source as shown in FIG. 8. The light beam from the light source is divided by a beam splitter into two light beams which are used as the recording/reproducing light and the optical change induction light, respectively. An objective lens having an NA of 0.65 and an LD having the wavelength of 405 nm are used as the recording/reproducing pickup. Further, the recording/reproducing light is divided by a beam splitter and an objective lens having the NA of 0.45 is used, thereby constituting the optical system for the optical change induction. A beam spot of the recording/reproducing light and a beam spot of the optical change induction light are arranged so as to coincide on the optical disk.

Although an example of the third embodiment according to the invention is explained hereinafter, the invention is not limited to the following example so long as not departing from the gist of the invention.

### THIRD EXAMPLE

### Single-Sided Three-Layer Type Read-Only Optical Recording Medium

The injection molding was performed on a polycarbonate substrate (hereinafter called the first substrate) with a thickness of 0.6 mm on which grooves each having a track pitch of 0.4 μm and a depth of 50 nm were formed, thereby forming the first recording layer. Then, a silver alloy film serving as the reflection film was formed on the first recording layer so as to have a thickness of 2 nm and further a ZnO film was formed thereon as the first optical change layer according to the embodiment so as to have a thickness of 50 nm.

Succeedingly, an UV cured resin was coated with a thickness of 20 μm as a first intermediate layer on the first optical change layer on the first substrate. Next, the second recording layer was formed by the injection molding on an acrylic substrate with a thickness of 1.1 mm thereby to prepare a substrate, in another process. Then, the second recording layer formed on the acrylic substrate was disposed on the surface of the UV cured resin, and an UV light was irradiated thereon while applying a pressure uniformly from both sides thereof to harden the UV cured resin, and the acrylic substrate was exfoliated from the UV cured resin. Thus, the second recording layer was formed on the UV cured resin. Further, the silver alloy film serving as the reflection film was formed on the second recording layer so as to have a thickness of 2 nm and furthermore a ZnO film was formed thereon as the second optical change layer according to the embodiment so as to have a thickness of 50 nm.

The injection molding was performed on a polycarbonate substrate (hereinafter called the second substrate) with a thickness of 0.6 mm on which grooves each having a track pitch of 0.4 μm and a depth of 50 nm were formed, thereby forming the third recording layer. Then, a silver alloy film serving as the third reflection film was formed on the third recording layer so as to have a thickness of 50 nm.

Finally, an UV cured resin was coated with a thickness of 20 μm as a second intermediate layer on the second optical change layer on the first substrate, and the coated surface of the UV cured resin was laminated with the film forming surface of the third reflection layer on the second substrate thereby to prepare the single-sided three-layer type read-only recording medium as shown in the figure. The disk thus formed is called a disk-E.

### COMPARATIVE EXAMPLE 3

### Single-Sided Three-Layer Type Read-Only Optical Recording Medium

A single-sided three-layer type read-only recording medium was prepared by the same material and the same processes as the third example except that the ZnO film serving as the optical change layer in the embodiment is eliminated. The disk thus formed is called a disk-F.

The CNR (carrier to noise ratio) of the 3T signal (in which each of the mark length and the space length is 0.306 μm) of each disk was measured.

Each of the L0, L1 and L2 layers was estimated. Supposing that the reflection factor and the transmissivity at the wavelength of the recording light before the reproducing are Rc and Tc, respectively, as to the disk-E, Rc=11.2% and Tc=xxx % for L0, Rc=12.5% and Tc=xxx % for L1 and Rc=11.0% and Tc=0% for L2, whilst as to the disk-F, Rc=13.8% and Tc=xxx % for L0, Rc=14.0% and Tc=xxx % for L1 and Rc=11.0% and Tc 0% for L2. As to each of the L0 and L1 layers, the reflection factor of the disk-F was higher than that of the disk-E and hence the transmissivity of the disk-F was lower than that of the disk-E. At the time of the reproducing test, the optical change induction light as well as the reproducing light was focused on the layer to be reproduced. The irradiation of the optical change induction light was stopped by a shutter at the time of reproducing the layer L2. After the recording, the reflection factor and the transmissivity of the space portion were measured in a state of irradiating the optical change induction light. Supposing that the reflection factor of the pit portion is Ra and the reflection factor and the transmissivity of the space portion are Rc* and Tc*, respectively, as to the disk-E, Rc*=15.8%, Ra=xxx % and Tc*=xxx % for L0, Rc*=16.2%, Ra=xxx % and Tc*=xxx % for L1, and Rc*=11.0%, Ra=xxx % and Tc*=0% for L2. On the other hand, as to the disk-F, Rc* was substantially same as Rc and Tc was also substantially same as Tc* for each of the first to third information layers, whilst Ra=xxx % for L0, Ra=xxx % for L1 and Ra=xxx % for L2. As to the disk-E, due to the irradiation of the optical change induction light, the reflection factor of each of the layers L0 and L1 increased and also the contrast of the reflection factor thereof increased. When the CNRs of the L0 and L1 layers were measured, it was proved that as to the disk-E, the CNRs were good values of 52.2 dB for the L0 layer and 51.9 dB for the layer L1 due to the two contributions that the contrast of the reflection factor was large and that the interlayer crosstalk from the non-recording/reproducing layer was reduced due to the reduction of the transmissivity which was caused by the irradiation of the optical change induction light on the optical change layer at the time of reproducing the respective layers. As to the disk-F, the CNRs were low values of 48.5 dB for the L0 layer and 47.2 dB for the layer L1. Further, as to the disk-E, the reflection factor became high due to the irradiation of the optical change induction light. In contrast, as to the disk-F, since the reflection factor was low, there sometimes arose a trouble that the light was defocused after a while even if the light was focused a the time of the disk estimation. Besides, the above results are arranged in Table 3, as follows.

TABLE 3

| Disk | | Rc | Tc | Ra | Rc* | Tc* | CNR |
|---|---|---|---|---|---|---|---|
| C | L0 | 11.2 | 81 | 6.8 | 15.8 | 76 | 52.2 |
| | L1 | 12.5 | 59 | 5.9 | 16.2 | 54 | 51.9 |
| | L2 | 11.0 | 0 | 6.2 | 11.0 | 0 | |
| D | L0 | 13.8 | 78 | 6.2 | 13.8 | 78 | 48.5 |
| | L1 | 14.0 | 56 | 5.5 | 14.0 | 56 | 47.2 |
| | L2 | 11.0 | 0 | 6.2 | 11.0 | 0 | |

The unit of each of the reflection factor and the transmissivity is % and the unit of CNR is dB.

The invention is not limited to the aforesaid embodiments as they are and the constituent elements thereof may be changed and realized in the embodying procedure within a scope not departing from the gist of the invention. Further, various modifications of the inventions may be realized by suitably combining the constituent elements disclosed in the aforesaid embodiments. For example, some of the constituent elements may be deleted from all the constituent elements of the embodiments. Furthermore, the constituent elements of the different embodiments may be suitably combined.

What is claimed is:

1. An optical recording medium comprising a plurality of information layers each having a recording layer for recording information, wherein
at least one of the information layers includes an optical change layer which optical constant changes by light irradiated thereon and restores to an original value after completion of the light irradiation.

2. The optical recording medium according to claim 1, wherein:
a film thickness of the information layer is equal to or less than 500 nm;
the optical change layer is disposed on an opposite side to an incident side of the light with respect to the recording layer;
the time constant includes a reflection factor and an attenuation coefficient; and
both the reflection factor and the attenuation coefficient increase or reduce in response to the light irradiation.

3. The optical recording medium according to claim 1, wherein
material of the optical change layer is selected from a group of ZnO, SnO₂, CeO₂, NiO₂, In₂O₃, TiO₂, Ta₂O₅, VO₂, SrTiO₃, AlGe.

4. The optical recording medium according to claim 1, wherein
the optical change layer includes transparent material and at least one selected from a group of dye dissolved or dispersed within the transparent material, metal particles dispersed within the transparent material and semiconductor particles dispersed within the transparent material.

5. The optical recording medium according to claim 1, wherein
material of the recording layer is selected from a group of a phase change film, an organic dye film and a magneto-optical recording film.

6. The optical recording medium according to claim 1, wherein
the recording layer includes a pattern of unevenness which is formed on a substrate or a resin.

7. An optical recording and reproducing apparatus, comprising:
an optical recording medium including a plurality of information layers each having a recording layer for recording information, at least one of the information layers having an optical change layer which optical constant changes by light irradiated thereon and restores to an original value after completion of the light irradiation;
a first light irradiation unit which irradiates first light on the optical change layer to change the optical constant; and
a second light irradiation unit which irradiates second light on the recording layer in a state where the optical constant is changed.

8. The optical recording and reproducing apparatus according to claim 7, wherein:
the first light and the second light are irradiated on a same guide groove on the optical recording medium; and
a diameter of a beam spot of the first light is equal to or lager than a diameter of a beam spot of the second light.

9. The optical recording and reproducing apparatus according to claim 8, wherein
when a rotary linear speed of the optical recording medium is v, when a time period required from a time point where the first light is irradiated to a time point where change of the optical constant is completed and then the optical constant restores to an original value is t, and when a distance between a center of the beam spot of the first light and a center of the beam spot of the second light is d, a relation of d≦v·t is satisfied.

10. The optical recording and reproducing apparatus according to claim 9, wherein
each of a wavelength of the first light and a wavelength of the second light is equal to or larger than 350 nm and equal to or smaller than 850 nm.
